(19) United States
(12) Patent Application Publication
(10) Pub. No.: US 2018/0193868 A1
(43) Pub. Date: Jul. 12, 2018

(54) ULTRASONIC SPRAY COATING MODULE

(71) Applicant: Precision Machinery Research Development Center, Taichung (TW)

(72) Inventors: Wei-Jen Lo, Chiayi (TW); Chi-Xian Chen, Chiayi (TW); Wei-Ming Chen, Chiayi (TW); Chi-Feng Li, Chiayi (TW)

(21) Appl. No.: 15/401,334

(22) Filed: Jan. 9, 2017

(51) Int. Cl. B05B 17/06

(52) U.S. Cl. CPC B05B 17/0623; B05B 17/0676

(57) ABSTRACT

A feeding mold is provided with a charging runner for coating, a feeding runner connected to the charging runner, and a mold base adjacent to the feeding runner. The feeding runner is provided with a splitting manifold communicated with the charging runner, a discharging end face located at the end of feeding runner and apart from an atomizing knife edge of ultrasonic oscillating element by a gap, and a slit channel connected to the splitting manifold and discharging end face. The mold base is connected at a side edge thereof to the bottom of discharging end face, and inclined at a first angle toward the discharging end face. The side edge is located at the lowest position. Accordingly, the backflow of coating on the discharging end face to the mold base from the side edge and formation of trickle are impossible, so as to use coating adequately and avoid pollution.

### FIELD OF THE INVENTION

The present invention is related to a spray coating machine, particularly to an ultrasonic spray coating module of the spray coating machine.

### BACKGROUND OF THE INVENTION

In the conventional ultrasonic atomization technology, such as U. S. patent publication no. US 2009/0061089, ultrasonic vibration is used to thrust liquid in the direction of vibration. Thus, the surface of liquid is formed with capillary ripples in the shape of intersecting parallels, and is broken after the singularity occurs owing to the increasing intensity of acoustic wave to form droplets to be sprayed at the top. The ultrasonic atomization technology is suitable for atomizing liquid with moderate viscosity. In comparison with rotary atomization technology and high-pressure atomization technology, higher spray coating utilization is obtained so as to reduce material. The smaller quantity of atomization and thus the lower efficiency of production are, however, the greatest drawbacks.

Referring to U.S. Pat. No. 5,409,163, there is disclosed an ultrasonic spray coating module including two air nozzles in cooperation with a fishtail feeding mold. An ultrasonic oscillating element is used to drive the fishtail feeding mold to oscillate ultrasonically. Further, the fishtail feeding mold is provided therein with a slot runner for the inflow of liquid raw material. After oscillated ultrasonically, the liquid raw material is atomized and then refined to form atomized droplets. Furthermore, the two air nozzles are allowed for providing air stream in two different directions, air stream in one direction being used as flow-directing gas for directing the atomized droplets to be flowed toward the area to be spray coated, and air stream in the other direction being used for blowing the end of the slot runner, so as to avoid the backflow of the atomized droplets along the end of the slot runner, and thus formed trickle owing to the backflow reaching the base of the fishtail feeding mold. In this conventional issued patent, the fishtail feeding mold is adopted, such that the runner is formed in a relatively stripe form, which may result in a problem of non-uniform flow rate. Further, more complex wiring and higher cost may be resulted from the necessity for two air nozzles. In addition, the air stream provided for avoiding the backflow of the atomized droplets is more or less possible to interfere with the other air stream provided for directing the atomized droplets, such that the atomized droplets are incapable of being flowed toward the area to be spray coated effectively. It is obviously that the use requirement could not be satisfied.

### SUMMARY OF THE INVENTION

It is the main object of the present invention to provide an ultrasonic spray coating module without trickle.

For achieving the above object, the present invention provides an ultrasonic spray coating module comprising an ultrasonic oscillating element, a feeding mold and an air nozzle. In this case, the ultrasonic oscillating element is provided with an atomizing knife edge. The feeding mold is provided with a charging runner for the inflow of coating, a feeding runner connected to the charging runner, and a mold base adjacent to the feeding runner. Further, the feeding runner is provided with a splitting manifold communicated with the charging runner, a discharging end face located at the end of the feeding runner and apart from the atomizing knife edge by a gap, and a slit channel connected to the splitting manifold and the discharging end face. The mold base is connected at a side edge thereof to the bottom of the discharging end face, and the mold base is inclined at a first angle toward the discharging end face. Moreover, the side edge of the mold base in proximity to the discharging end face is located at the lowest position. In addition, the air nozzle is provided with a flow-directing gas being oriented toward a spray coating direction and aiming at the atomizing knife edge.

Accordingly, the mold base is inclined at the first angle toward the discharging end face, such that the side edge of the mold base in proximity to the discharging end face is located at the lowest position, without the possibility of backflow of the coating on the discharging end face to the mold base from the side edge. That is to say, trickle is not formed from the coating, so as to enable adequate use of the coating and avoid the occurrence of pollution.

### BRIEF DESCRIPTION OF THE DRAWINGS

FIG. 1 is a structural front view of the present invention.

FIG. 2 is a structural perspective view of a feeding mold of the present invention.

FIG. 3 is a structural side view of the feeding mold of the present invention.

### DETAILED DESCRIPTION OF THE PREFERRED EMBODIMENTS

The detailed technical content of the present invention will now be described in combination with drawings as follows.

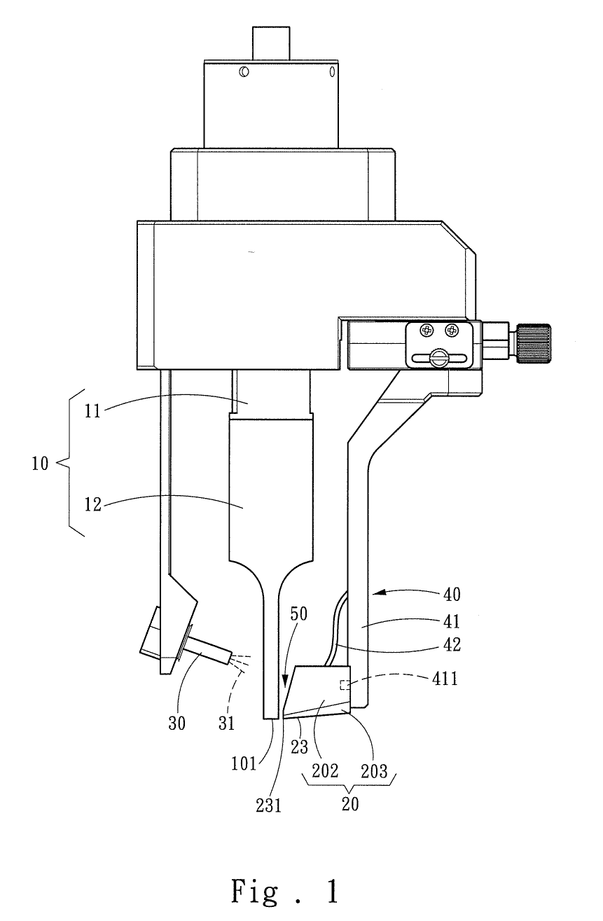

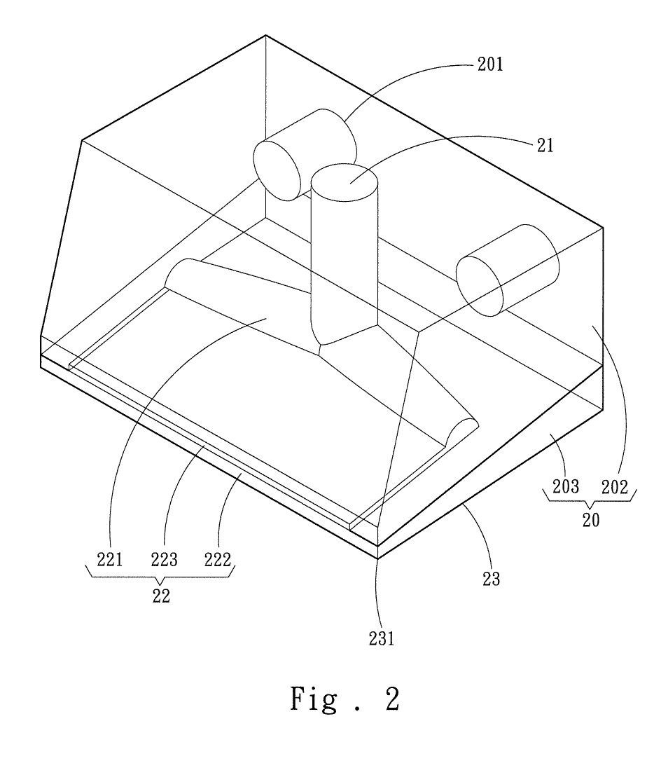

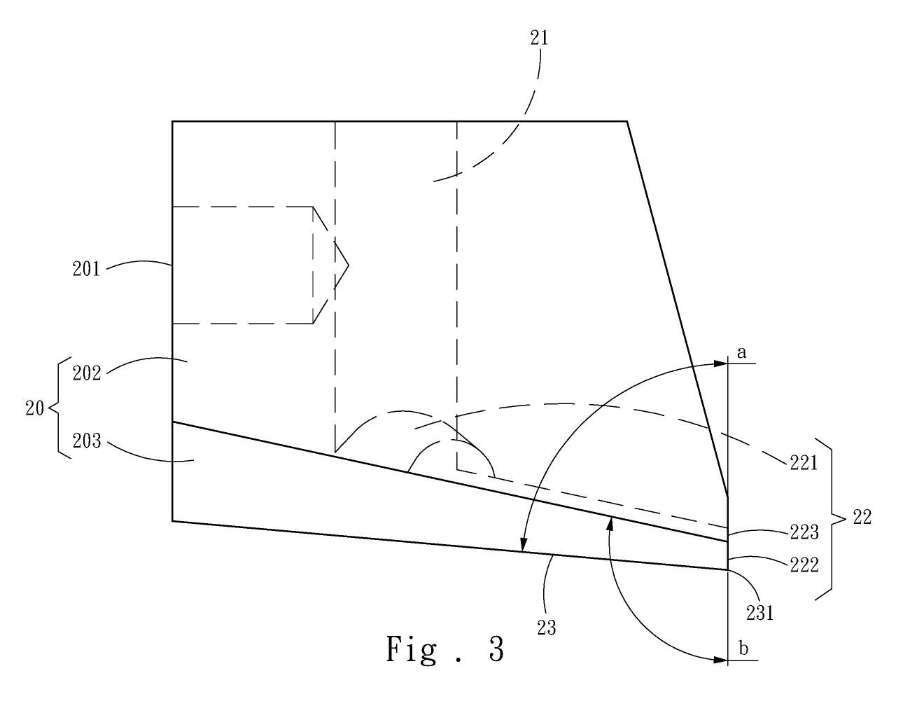

Referring to FIGS. 1, 2 and 3, there are shown a front view, a structural perspective view of a mold, and a structural side view of the mold, respectively, of one preferred embodiment of the present invention. As illustrated in the figures, the present invention is related to an ultrasonic spray coating module comprising an ultrasonic oscillating element 10 including an atomizing knife edge 101, a feeding mold 20, and an air nozzle 30. In the practical structure, the ultrasonic oscillating element 10 may include a piezoelectric transducer 11 converting electrical energy into mechanical vibration, and an ultrasonic horn 12 provided on the piezoelectric transducer 11. The ultrasonic horn 12 is presented at the end thereof, moreover, as the atomizing knife edge 101. The function of the ultrasonic horn 12 is enlargement of particle displacement or velocity of mechanical vibration, and concentration of energy on a smaller area (i.e., at the atomizing knife edge 101).

The feeding mold 20 is provided with a charging runner 21 for the inflow of coating (not shown), a feeding runner 22 connected to the charging runner 21, and a mold base 23 adjacent to the feeding runner 22. Moreover, the present invention may further comprise a feeding part 40 including a feeding head 41 and a feeding tube 42. The feeding mold 20 is fixed to the feeding head 41. In the practical structure, the feeding head 41 may be provided with at least one positioning post 411, while the feeding mold 20 is provided with at least one positioning hole 201 corresponding to the at least one positioning post 411, such that the feeding mold 20 may be fixed to the feeding head 41 by inserting the positioning posts 411 into the positioning holes 201. The feeding tube 42 is communicated with the charging runner 21. Coating necessary for ultrasonic spray coating is supplied by the feeding tube 42, such that the coating is introduced into the charging runner 21.

The feeding runner 22 is then provided with a splitting manifold 221 communicated with the charging runner 21, a discharging end face 222 located at the end of the feeding runner 22 and apart from the atomizing knife edge 101 by a gap 50, and a slit channel 223 connected to the splitting manifold 221 and the discharging end face 222. The mold base 23 is connected at a side edge 231 thereof to the bottom of the discharging end face 222, and the discharging end face 222 is preferably designed to be vertical. Further, the mold base 23 is inclined at a first angle a toward the discharging end face 222, with a preferable first angle a of between 4° to 10°. Moreover, the side edge 231 of the mold base 23 in proximity to the discharging end face 222 is located at the lowest position Furthermore, the slit channel 223 may be inclined at a second angle b toward the discharging end face 222, with a preferable second angle b of between 6° to 15°.

The air nozzle 30 is then provided with a flow-directing gas 31 being oriented toward a spray coating direction and aiming at the atomizing knife edge 101. The orientation of the air nozzle 30 is selected depending upon the required spray coating direction, while the main function thereof is providing the flow-directing gas 31. The atomized coating is directed to the object to be spray coated through the flow-directing gas 31. Additionally, the feeding mold 20 may include an upper die 202 and a lower die 203 with the slit channel 223 situated therebetween in consideration of the convenience for manufacturing, in such a way that difficulty in manufacturing the feeding mold 20 may be lowered significantly.

After entering the charging runner 21, the coating may be spread out through the splitting manifold 221 presented as a shape of clothes hanger, which is referred to an overall appearance of the splitting manifold 221 being similar to the clothes hanger for hanging up clothes, demonstrating a near-center region at the highest position with two lower sides. After spread out through the splitting manifold 221, the coating is then allowed to pass through the slit channel 223 and enter the discharging end face 222. At this time, the coating entering the discharging end face 222 may be contacted with the atomizing knife edge 101 and then atomized, due to the gap 50 kept between the discharging end face 222 and the atomizing knife edge 101. Further, the atomized coating may be blown away by the flow-directing gas 31 from the air nozzle 30 in the spray coating direction.

To sum up, the advantages of the present invention in comparison with the prior art at least include:

1. inclination at the first angle of the mold base toward the discharging end face, such that the side edge of the discharging end face in proximity to the mold base is located at the lowest position, without the possibility of backflow of the coating on the discharging end face to the mold base from the side edge, i.e., without forming trickle from the coating, in which, for the preferred first angle, only greater than 4° is required, while the angle greater than 10° is inappropriate because oversized angle may affect the strength of structure,

2. more uniform flow rate when the clothes hanger-shaped splitting manifold is adopted for shear-thinning fluid (Newtonian fluid),

3. cost savings in manufacturing and effective control of flow direction of atomized coating because only one single air nozzle is required,

4. inclination at the second angle of the slit channel toward the discharging end face, such that accumulation of the coating in the slit channel and the problem of obstruction due to the coating are avoided, in which the second angle between 6° and 15° is preferred, because the flow velocity of the coating is lower at the angle smaller than 6° so as to result in liability to accumulated obstruction or insufficient power for driving the coating flowed out of the discharging end face to contact with the atomizing knife edge, while the coating is liable to incapability of flowing to the discharging end face through the slit channel uniformly at the angle larger than 15°.

1. An ultrasonic spray coating module, comprising:
an ultrasonic oscillating element, provided with an atomizing knife edge;
a feeding mold, provided with a charging runner for an inflow of coating, a feeding runner connected to the charging runner, and a mold base adjacent to the feeding runner, the feeding runner being provided with a splitting manifold communicated with the charging runner, a discharging end face located at an end of the feeding runner and apart from the atomizing knife edge by a gap, and a slit channel connected to the splitting manifold and the discharging end face, wherein a side edge of the mold base is connected at a bottom of the discharging end face, and a first angle is located between the mold base and the discharging end face, while the side edge of the mold base in proximity to the discharging end face being located at a lowest position; and
an air nozzle, provided with a flow-directing gas being oriented toward a spray coating direction and aiming at the atomizing knife edge.

2. The ultrasonic spray coating module according to claim 1, wherein the ultrasonic oscillating element comprises a piezoelectric transducer and an ultrasonic horn, the ultrasonic horn being provided on the piezoelectric transducer and the ultrasonic horn is presented at an end thereof as the atomizing knife edge.

3. The ultrasonic spray coating module according to claim 1, further comprising a feeding part including a feeding head and a feeding tube, the feeding mold being fixed to the feeding head and the feeding tube being communicated with the charging runner.

4. The ultrasonic spray coating module according to claim 3, wherein the feeding head is provided with at least one positioning post, while the feeding mold is provided with at least one positioning hole corresponding to the at least one positioning post.

5. The ultrasonic spray coating module according to claim 1, wherein the feeding mold comprises an upper die and a lower die with the slit channel situated therebetween.

6. The ultrasonic spray coating module according to claim 1, wherein the splitting manifold is V-shaped.

7. The ultrasonic spray coating module according to claim 1, wherein the first angle is in a range of 80° to 86°.

8. The ultrasonic spray coating module according to claim 1, wherein a second angle is located between the slit channel and the discharging end face.

9. The ultrasonic spray coating module according to claim 8, wherein the second angle is preferably in a range of 96° to 105°.

10. The ultrasonic spray coating module according to claim 1, wherein the discharging end face is provided vertically.
